(19) United States
(12) Patent Application Publication
(10) Pub. No.: US 2025/0316931 A1
(43) Pub. Date: Oct. 9, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/098,482

(22) Filed: Apr. 2, 2025

(30) Foreign Application Priority Data
Apr. 3, 2024 (TW) 113203388

(51) Int. Cl. H01R 13/6585; H01R 12/75; H01R 13/02; H01R 13/447; H01R 13/6598

(52) U.S. Cl. CPC H01R 13/6585; H01R 12/75; H01R 13/02; H01R 13/447; H01R 13/6598

(57) ABSTRACT

An electrical connector capable of transmitting signals, wherein the electrical connector is electrically joinable to a joining element, and the electrical connector is further electrically connectable to a coaxial cable assembly for signal transmission. The electrical connector comprises a terminal joining shielding structure and a terminal connecting shielding structure, wherein the terminal joining shielding structure is configured to provide shielding for the joining between the electrical connector and the joining element, and the terminal connecting shielding structure is configured to provide shielding for the connecting between the electrical connector and the coaxial cable assembly, so as to reduce the degree of signal transmission interference among the electrical connector, the joining element, and the coaxial cable assembly, thereby satisfying the signal transmission requirements of the electrical connector.

### CROSS-REFERENCE TO RELATED APPLICATIONS

This application claims the priority of Republic of China Patent Application No. 113203388 filed on Apr. 3, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector configured to provide shielding to meet signal transmission requirements.

### Descriptions of the Related Art

In recent years, electrical connectors have been widely applied to various electronic devices. However, due to the special requirements and development of electronic devices, the demand for signal transmission by electrical connectors has been increasing day by day. Nevertheless, existing electrical connectors are limited by poor shielding performance resulting from mechanical design, which often leads to signal interference during transmission. As a result, signal attenuation and distortion may occur during the signal transmission process of the electrical connector, making it difficult to meet the signal transmission requirements. The aforementioned interference includes, for example, electromagnetic interference (EMI) or noise crosstalk interference.

Therefore, how to reduce the interference encountered by electrical connectors during signal transmission has become an urgent problem to be solved by those skilled in the art.

### SUMMARY OF THE INVENTION

In view of the drawbacks of the prior art mentioned above, the present application provides an electrical connector, the electrical connector is joined to a joining element, and the electrical connector is connected to a first major coaxial cable and a first minor coaxial cable, the first major coaxial cable comprising a first major cable center conductor, and the first minor coaxial cable comprising a first minor cable center conductor, wherein the electrical connector comprises: a shielding conductor component, the shielding conductor component comprising a terminal joining shielding structure and a terminal connecting shielding structure; a major electrical connector component, the major electrical connector component comprising a major component insulation core and a major component conductive terminal assembly; the major component insulation core comprising a major core joining port and a major core connecting port, the major component conductive terminal assembly comprising a first major terminal, the first major terminal comprising a first major terminal joining structure and a first major terminal connecting structure; wherein the major component insulation core is mated with the first major terminal such that the first major terminal joining structure is positioned at the major core joining port for joining with the joining element, and the first major terminal connecting structure is positioned at the major core connecting port for connecting with the first major cable center conductor; and a minor electrical connector component, the minor electrical connector component comprising a minor component insulation core and a minor component conductive terminal assembly; the minor component insulation core comprising a minor core joining port and a minor core connecting port, the minor component conductive terminal assembly comprising a first minor terminal, the first minor terminal comprising a first minor terminal joining structure and a first minor terminal connecting structure; wherein the minor component insulation core is mated with the first minor terminal such that the first minor terminal joining structure is positioned at the minor core joining port for joining with the joining element, and the first minor terminal connecting structure is positioned at the minor core connecting port for connecting with the first minor cable center conductor; wherein the major electrical connector component and the shielding conductor component are combined to form a first electrical connector combination element; the minor electrical connector component and the first electrical connector combination element are combined to form a second electrical connector combination element, in the second electrical connector combination element, the terminal joining shielding structure is located between the major core joining port and the minor core joining port, such that the terminal joining shielding structure provides shielding between the first major terminal joining structure and the first minor terminal joining structure; and the terminal connecting shielding structure is located between the major core connecting port and the minor core connecting port, such that the terminal connecting shielding structure provides shielding between the first major terminal connecting structure and the first minor terminal connecting structure.

Preferably, the electrical connector said above, wherein the shielding conductor component is formed of a conductive metal sheet.

Preferably, the electrical connector said above, wherein the first major coaxial cable and the first minor coaxial cable further respectively comprise a first major cable braided layer and a first minor cable braided layer, wherein, the major electrical connector component further comprises a major component conductive bridging body, the major component conductive bridging body comprising a major shielding conductor abutting structure and a first major cable abutting structure; the minor electrical connector component further comprises a minor component conductive bridging body, the minor component conductive bridging body comprising a minor shielding conductor abutting structure and a first minor cable abutting structure; and in the first electrical connector combination element, the major shielding conductor abutting structure and the first major cable abutting structure are respectively electrically abutted with the shielding conductor component and the first major cable braided layer, and the minor shielding conductor abutting structure and the first minor cable abutting structure are respectively electrically abutted with the shielding conductor component and the first minor cable braided layer, such that the major component conductive bridging body, the minor component conductive bridging body, the shielding conductor component, the first major cable braided layer and the first minor cable braided layer are electrically connected to transmit a shielding signal.

Preferably, the electrical connector said above, wherein the electrical connector is further connected to a second major coaxial cable and a second minor coaxial cable, the second major coaxial cable comprising a second major cable center conductor and a second major cable braided layer, the second minor coaxial cable comprising a second minor cable center conductor and a second minor cable braided layer; wherein, the major component conductive terminal assembly further comprises a second major terminal, the second major terminal comprising a second major terminal joining structure and a second major terminal connecting structure; and the major component insulation core is further mated with the second major terminal, such that the second major terminal joining structure is positioned at the major core joining port for joining with the joining minor terminal connecting structure; and the minor component insulation core is further mated with the second minor terminal, such that the second minor terminal joining structure is positioned at the minor core joining port for joining with the joining element, and the second minor terminal connecting structure is positioned at the minor core connecting port for connecting with the second minor cable center conductor; the major component conductive bridging body further comprises a second major cable abutting structure; the minor component conductive bridging body further comprises a second minor cable abutting structure; and in the first electrical connector combination element, the second major cable abutting structure is electrically abutted with the second major cable braided layer for transmitting the shielding signal; and the second minor cable abutting structure is electrically abutted with the second minor cable braided layer for transmitting the shielding signal.

Preferably, the electrical connector said above, further comprising a metal outer cover component, the metal outer cover component comprising a major cover body and a minor cover body; the metal outer cover component and the second electrical connector combination element are combined to form a third electrical connector combination element, in the third electrical connector combination element, the major cover body is extended around the major core joining port, so as to provide shielding for the first major terminal joining structure to join with the joining element; and the major cover body is further extended around the major core connecting port, so as to provide shielding for the first major terminal connecting structure to connect with the first major cable center conductor; and the minor cover body is extended around the minor core joining port, so as to provide shielding for the first minor terminal joining structure to join with the joining element; and the minor cover body is further extended around the minor core connecting port, so as to provide shielding for the first minor terminal connecting structure to connect with the first minor cable center conductor.

Preferably, the electrical connector said above, wherein the major cover body and the minor cover body respectively comprise a major cover body abutting structure and a minor cover body abutting structure, in the second electrical connector combination element, the major cover body abutting structure and the minor cover body abutting structure are respectively electrically abutted with the major component conductive bridging body and the minor component conductive bridging body, such that the major cover body and the minor cover body are capable of transmitting the shielding signal.

Preferably, the electrical connector said above, wherein the major cover body and the minor cover body respectively comprise a major cover body supporting structure and a minor cover body supporting structure, in the second electrical connector combination element, the major cover body supporting structure and the minor cover body supporting structure respectively contact the major component conductive bridging body and the minor component conductive bridging body, such that the major cover body and the minor cover body respectively provide structural support to the major component conductive bridging body and the minor component conductive bridging body.

Preferably, the electrical connector said above, wherein the major component insulation core further comprises a shielding conductor component combination guiding structure, a shielding conductor component combination space, a shielding conductor component longitudinal stop structure, and a shielding conductor component lateral stop structure; the shielding conductor component combination guiding structure is configured to guide the shielding conductor component into the shielding conductor component combination space, such that the major electrical connector component and the shielding conductor component are combined to form the first electrical connector combination element; in the first electrical connector combination element, the shielding conductor component longitudinal stop structure is configured to stop the shielding conductor component from moving longitudinally out of the shielding conductor component combination space; and the shielding conductor component lateral stop structure is configured to stop the shielding conductor component from moving laterally out of the shielding conductor component combination space.

Preferably, the electrical connector said above, wherein the shielding conductor component longitudinal stop structure is a hook-shaped stop structure disposed at the major core joining port, the terminal joining shielding structure further comprises a terminal joining shielding structure threading passage and a shielding conductor component longitudinal interference structure; in the first electrical connector combination element, the shielding conductor component longitudinal stop structure passes through the terminal joining shielding structure threading passage, so as to prevent the shielding conductor component longitudinal stop structure from interfering with the shielding conductor component entering the shielding conductor component combination space, and the shielding conductor component longitudinal interference structure interferes with the longitudinal movement of the shielding conductor component relative to the shielding conductor component longitudinal stop structure, such that the shielding conductor component longitudinal stop structure is able to stop the shielding conductor component from moving longitudinally out of the shielding conductor component combination space.

Preferably, the electrical connector said above, wherein the shielding conductor component lateral stop structure is a groove-shaped stop structure disposed at the major component insulation core, the shielding conductor component further comprises a shielding conductor component lateral interference structure; in the first electrical connector combination element, the shielding conductor component lateral interference structure enters the shielding conductor component lateral stop structure, so as to prevent the shielding conductor component lateral stop structure from interfering with the shielding conductor component entering the shielding conductor component combination space, and the shielding conductor component lateral interference structure interferes with the lateral movement of the shielding conductor component relative to the shielding conductor component lateral stop structure, such that the shielding conductor component lateral stop structure is able to stop the shielding conductor component from moving laterally out of the shielding conductor component combination space.

Preferably, the electrical connector said above, wherein the major component insulation core further comprises a minor electrical connector component combination guiding structure, a minor electrical connector component combination space, a minor electrical connector component longitudinal stop structure, and a minor electrical connector component lateral stop structure; the minor electrical connector component combination guiding structure is configured to guide the minor electrical connector component into the minor electrical connector component combination space, such that the minor electrical connector component and the first electrical connector combination element are combined to form the second electrical connector combination element; in the second electrical connector combination element, the minor electrical connector component longitudinal stop structure is configured to stop the minor electrical connector component from moving longitudinally out of the minor electrical connector component combination space; and the minor electrical connector component lateral stop structure is configured to stop the minor electrical connector component from moving laterally out of the minor electrical connector component combination space.

Preferably, the electrical connector said above, wherein the minor electrical connector component longitudinal stop structure is a hook- shaped stop structure disposed at the major core joining port, the minor electrical connector component further comprises a minor electrical connector component threading passage and a minor electrical connector component longitudinal interference structure; in the second electrical connector combination element, the minor electrical connector component longitudinal stop structure passes through the minor electrical connector component threading passage, so as to prevent the minor electrical connector component longitudinal stop structure from interfering with the minor electrical connector component entering the minor electrical connector component combination space, and the minor electrical connector component longitudinal interference structure interferes with the longitudinal movement of the minor electrical connector component relative to the minor electrical connector component longitudinal stop structure, such that the minor electrical connector component longitudinal stop structure is able to stop the minor electrical connector component from moving longitudinally out of the minor electrical connector component combination space.

Preferably, the electrical connector said above, wherein the minor electrical connector component lateral stop structure is a groove-shaped stop structure disposed at the major component insulation core, the minor electrical connector component further comprises a minor electrical connector component lateral interference structure; in the second electrical connector combination element, the minor electrical connector component lateral interference structure enters the minor electrical connector component lateral stop structure, so as to prevent the minor electrical connector component lateral stop structure from interfering with the minor electrical connector component entering the minor electrical connector component combination space, and the minor electrical connector component lateral interference structure interferes with the lateral movement of the minor electrical connector component relative to the minor electrical connector component lateral stop structure, such that the minor electrical connector component lateral stop structure is able to stop the minor electrical connector component from moving laterally out of the minor electrical connector component combination space.

Compared with the prior art, the present application provides an electrical connector capable of transmitting signals, wherein the electrical connector is electrically joinable to a joining element, and the electrical connector is further electrically connectable to a coaxial cable assembly for signal transmission. The electrical connector comprises a terminal joining shielding structure and a terminal connecting shielding structure, wherein the terminal joining shielding structure is configured to provide shielding for the joining between the electrical connector and the joining element, and the terminal connecting shielding structure is configured to provide shielding for the connecting between the electrical connector and the coaxial cable assembly, so as to reduce the degree of signal transmission interference among the electrical connector, the joining element, and the coaxial cable assembly, thereby satisfying the signal transmission requirements of the electrical connector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of the electrical connector according to an embodiment of the present application.

FIG. 2 is a schematic front view of the electrical connector according to an embodiment of the present application.

FIG. 3 is a schematic side view of the electrical connector according to an embodiment of the present application.

FIG. 4 is a schematic sectional view taken along line AA of partial components of the electrical connector shown in FIG. 2.

FIG. 5 is a schematic perspective view from a first viewing angle of the electrical connector according to an embodiment of the present application.

FIG. 6 is a schematic perspective view from a second viewing angle of the electrical connector according to an embodiment of the present application.

FIG. 7 is a schematic perspective view from a first viewing angle of partial components of the electrical connector according to an embodiment of the present application.

FIG. 8 is a schematic perspective view from a second viewing angle of partial components of the electrical connector according to an embodiment of the present application.

FIG. 9 is a schematic perspective view of partial components of the electrical connector according to an embodiment of the present application.

FIG. 10 is a schematic perspective view of partial components of the electrical connector according to an embodiment of the present application.

FIG. 11 is a schematic perspective view of the electrical connector according to an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

It should be noted that, for the sake of conciseness and clarity of disclosure, elements having the same or similar functions in the following embodiments will be denoted by the same reference numerals, and descriptions of identical or equivalent features will be omitted.

The present application provides an electrical connector capable of transmitting signals, wherein the electrical connector is electrically joinable to a joining element, and the electrical connector is further electrically connectable to a coaxial cable assembly for signal transmission. The electrical connector comprises a terminal joining shielding structure and a terminal connecting shielding structure, wherein the terminal joining shielding structure is configured to provide shielding for the joining between the electrical connector and the joining element, and the terminal connecting shielding structure is configured to provide shielding for the connecting between the electrical connector and the coaxial cable assembly, so as to reduce the degree of signal transmission interference among the electrical connector, the joining element, and the coaxial cable assembly, thereby satisfying the signal transmission requirements of the electrical connector.

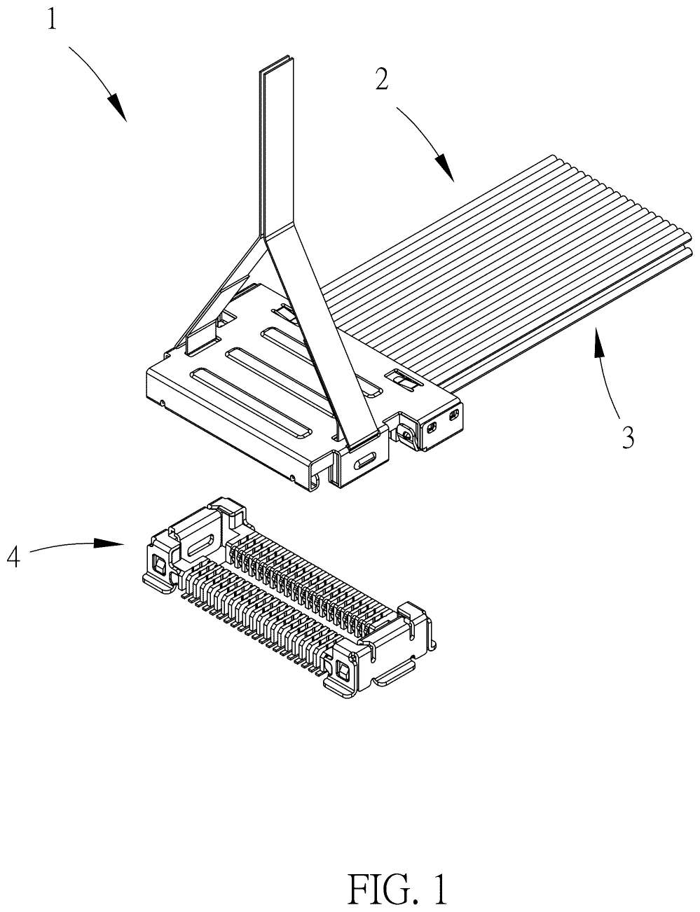

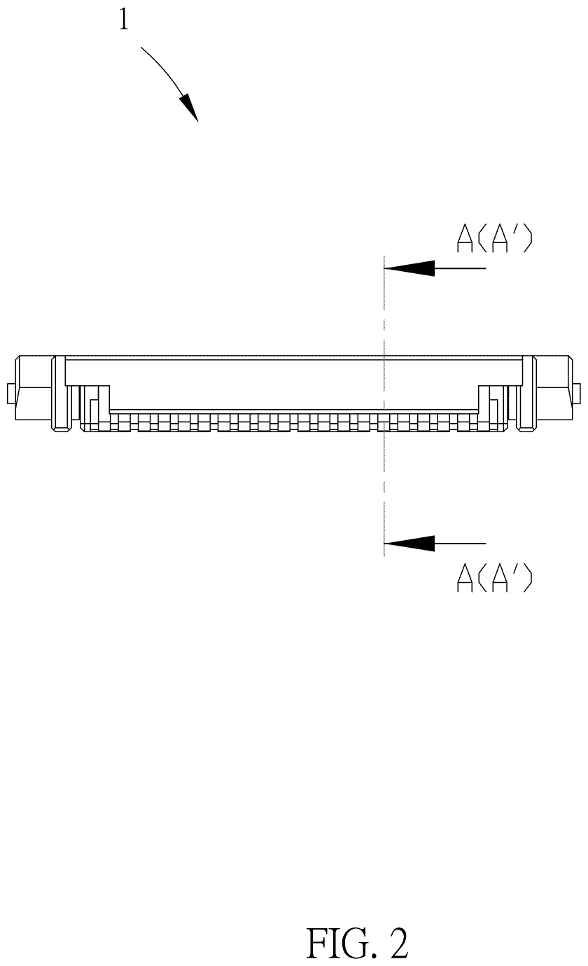

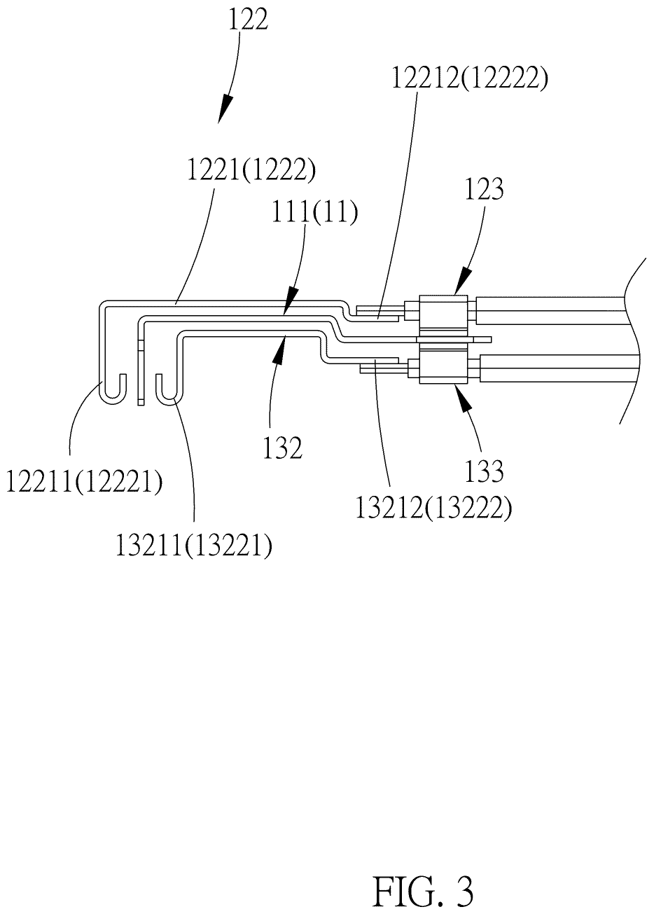

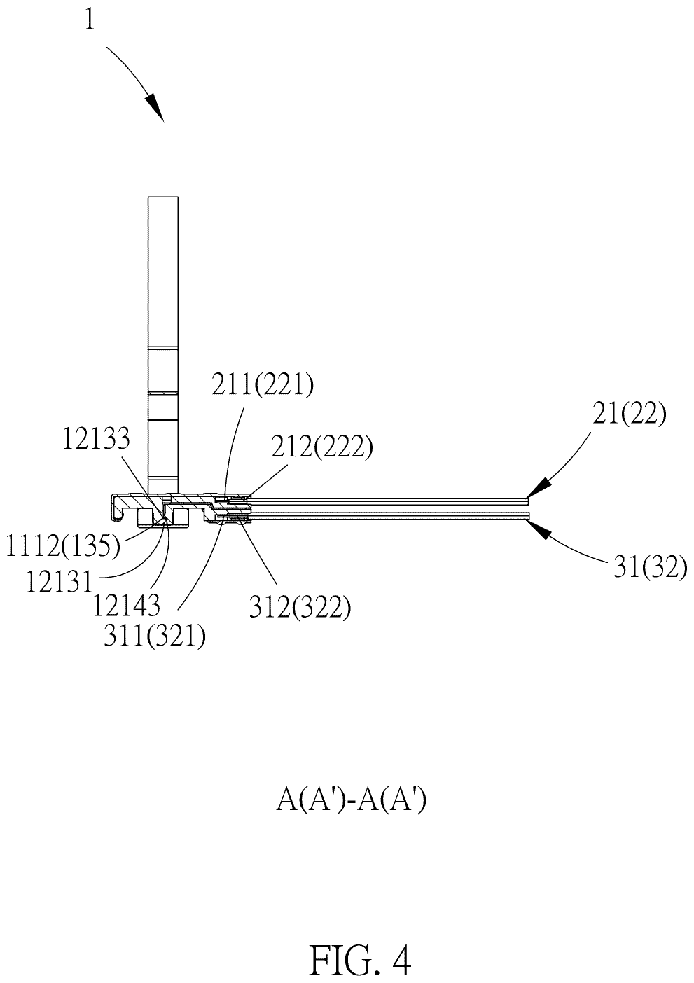

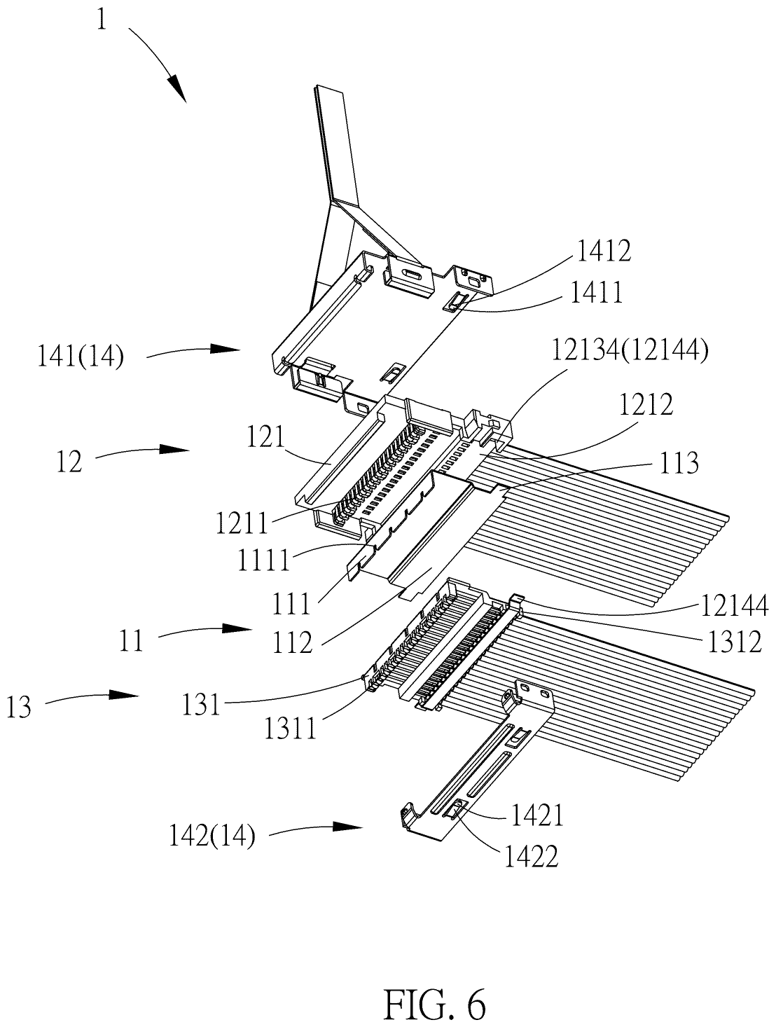

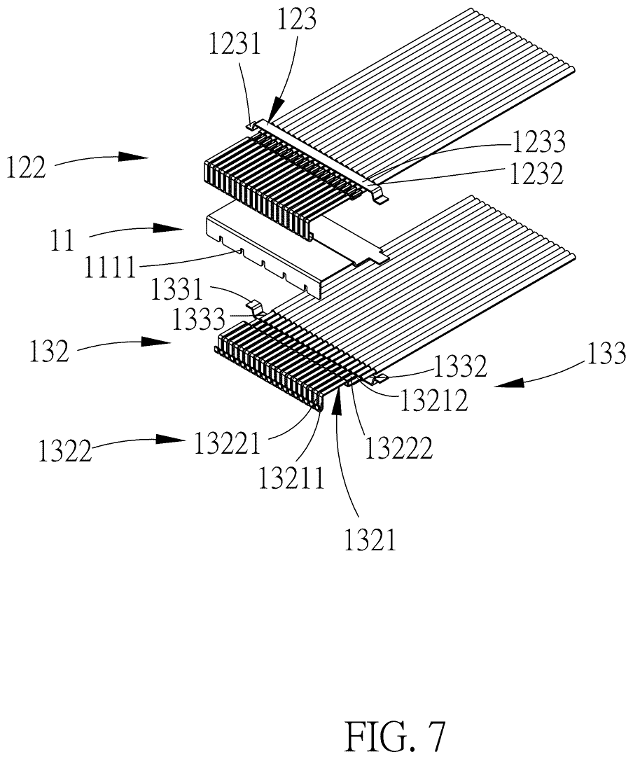

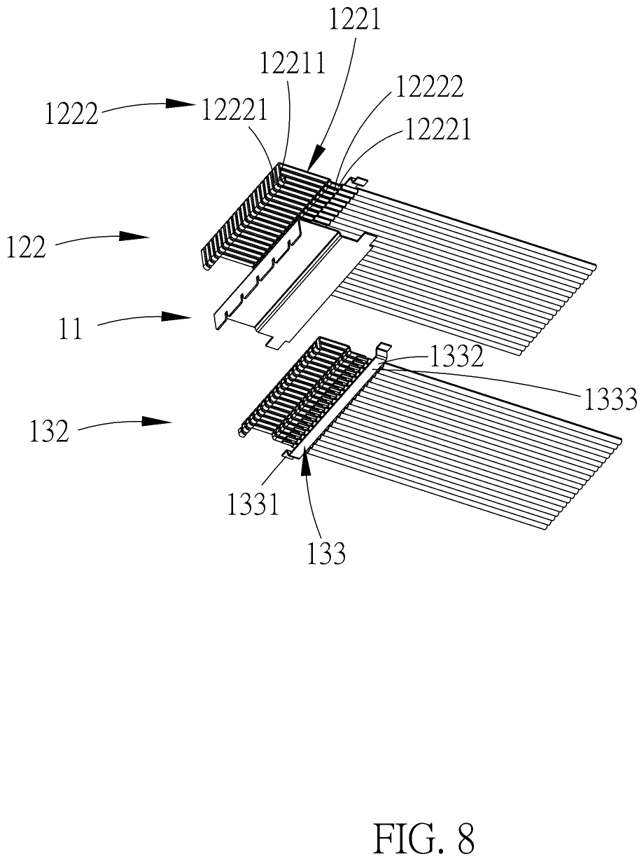

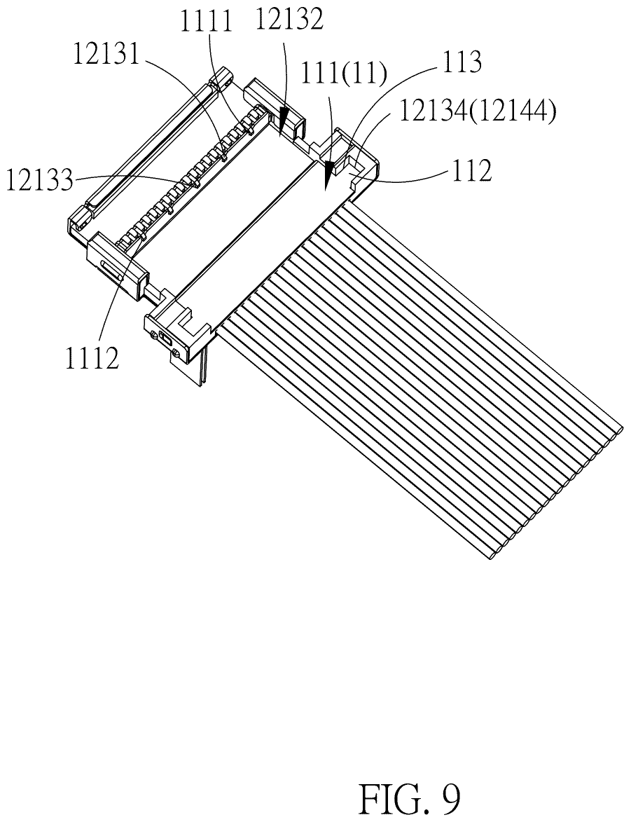

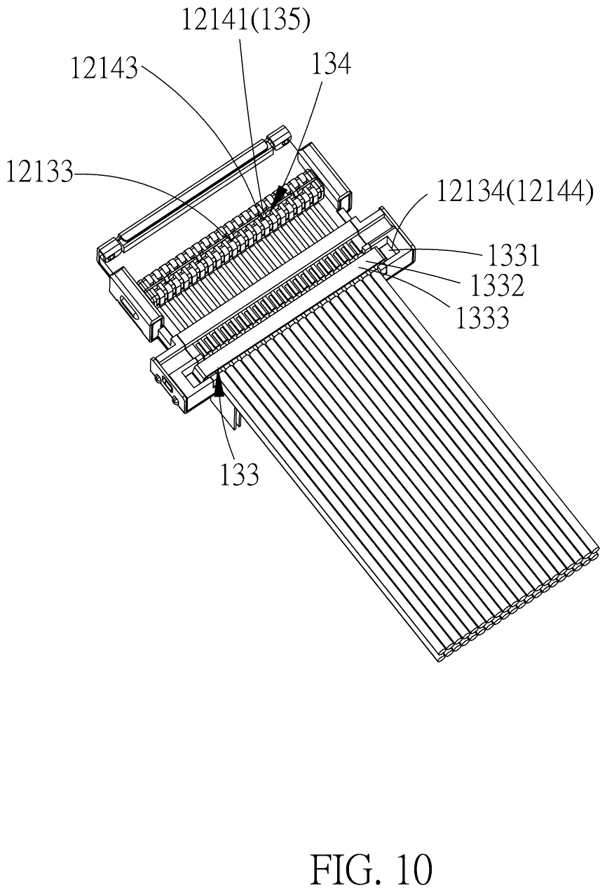

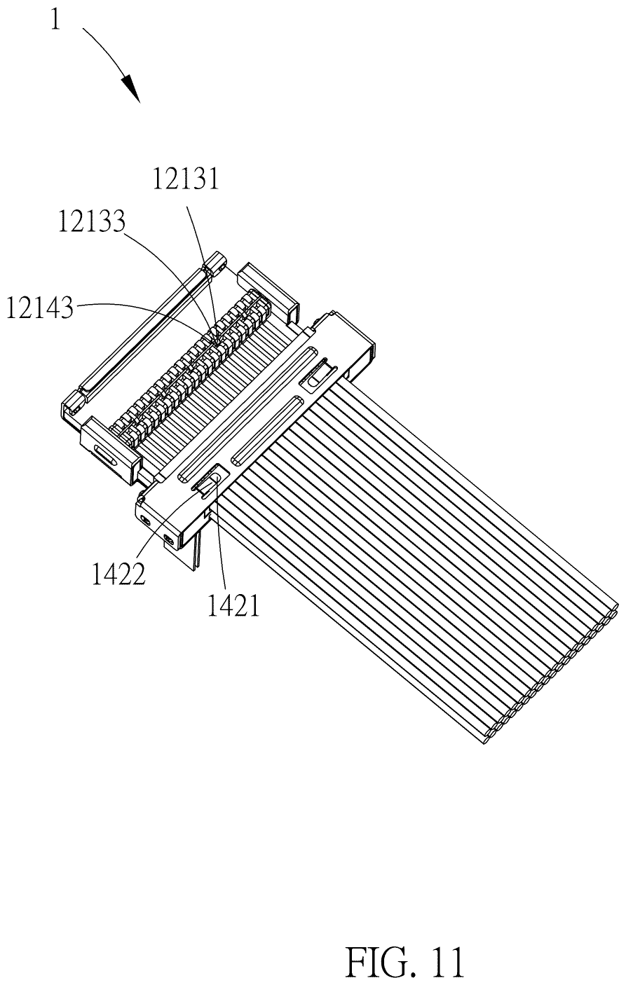

For a detailed description of the embodiments disclosed in the present application, please refer to FIGS. 1 to 11.

In the embodiments shown in FIGS. 1 to 11 of the present application, the electrical connector 1 is joinable to a joining element 4 and connectable to a major coaxial cable assembly 2 and a minor coaxial cable assembly 3. The major coaxial cable assembly 2 comprises a first major coaxial cable 21 and a second major coaxial cable 22. The minor coaxial cable assembly 3 comprises a first minor coaxial cable 31 and a second minor coaxial cable 32. The electrical connector 1 is optionally implemented as an LVDS (Low-voltage differential signaling) cable-end connector, and correspondingly, the electrical connector 1 is optionally implemented as a board-end connector.

In the above embodiment, the first major coaxial cable 21 comprises a first major cable center conductor 211 and a first major cable braided layer 212, wherein the first major cable braided layer 212 extends around the periphery of the first major cable center conductor 211 and transmits a shielding signal to provide shielding for the first major cable center conductor 211. The second major coaxial cable 22 comprises a second major cable center conductor 221 and a second major cable braided layer 222, wherein the second major cable braided layer 222 extends around the periphery of the second major cable center conductor 221 and transmits a shielding signal to provide shielding for the second major cable center conductor 221. The first minor coaxial cable 31 comprises a first minor cable center conductor 311 and a first minor cable braided layer 312, wherein the first minor cable braided layer 312 extends around the periphery of the first minor cable center conductor 311 and transmits a shielding signal to provide shielding for the first minor cable center conductor 311. The second minor coaxial cable 32 comprises a second minor cable center conductor 321 and a second minor cable braided layer 322, wherein the second minor cable braided layer 322 extends around the periphery of the second minor cable center conductor 321 and transmits a shielding signal to provide shielding for the second minor cable center conductor 321.

In the above embodiment, the electrical connector 1 comprises: a shielding conductor component 11, a major electrical connector component 12, a minor electrical connector component 13, and a metal outer cover component 14.

The shielding conductor component 11 is optionally made of a conductive metal sheet or conductive plastic, and is configured to absorb electromagnetic waves and/or transmit a shielding signal. The shielding conductor component 11 comprises a terminal joining shielding structure 111 and a terminal connecting shielding structure 112.

In addition, the major electrical connector component 12 and the minor electrical connector component 13 are optionally configured as a symmetrical structure, so as to simplify the manufacturing process of the electrical connector 1 and reduce the manufacturing cost thereof.

The major electrical connector component 12 comprises a major component insulation core 121, a major component conductive terminal assembly 122, and a major component conductive bridging body 123. The major component insulation core 121 is optionally made of an insulating material, and comprises a major core joining port 1211, a major core connecting port 1212, a shielding conductor component combination guiding structure 12131, a shielding conductor component combination space 12132, a shielding conductor component longitudinal stop structure 12133, a shielding conductor component lateral stop structure 12134, a minor electrical connector component combination guiding structure 12141, a minor electrical connector component combination space 12142, a minor electrical connector component longitudinal stop structure 12143, and a minor electrical connector component lateral stop structure 12144. The major component conductive terminal assembly 122 and the major component conductive bridging body 123 are optionally made of a conductive material.

The shielding conductor component longitudinal stop structure 12133 is a hook-shaped stop structure disposed at the major core joining port 1211. Correspondingly, the terminal joining shielding structure 111 further comprises a terminal joining shielding structure threading passage 1111 and a shielding conductor component longitudinal interference structure 1112. In addition, the shielding conductor component lateral stop structure 12134 is a groove-shaped stop structure disposed at the major component insulation core 121. Correspondingly, the shielding conductor component 11 further comprises a shielding conductor component lateral interference structure 113, which is a block-shaped interference structure disposed at the shielding conductor component 11.

The minor electrical connector component longitudinal stop structure 12143 is a hook-shaped stop structure disposed at the major core joining port 1211. Correspondingly, the minor electrical connector component 13 further comprises a minor electrical connector component threading passage 134 and a minor electrical connector component longitudinal interference structure 135. In addition, the minor electrical connector component lateral stop structure 12144 is a groove-shaped stop structure disposed at the major component insulation core 121. Correspondingly, the minor electrical connector component 13 further comprises a minor electrical connector component lateral interference structure 136, which is a block-shaped interference structure disposed at the minor component insulation core 131.

The major component conductive terminal assembly 122 comprises a first major terminal 1221 and a second major terminal 1222, which are configured to provide signal transmission. The first major terminal 1221 comprises a first major terminal joining structure 12211 and a first major terminal connecting structure 12212. The second major terminal 1222 comprises a second major terminal joining structure 12221 and a second major terminal connecting structure 12222. The major component conductive bridging body 123 comprises a major shielding conductor abutting structure 1231, a first major cable abutting structure 1232, and a second major cable abutting structure 1233.

Wherein, the major component insulation core 121 is mated with the first major terminal 1221 and the second major terminal 1222, such that the first major terminal joining structure 12211 and the second major terminal joining structure 12221 are respectively located at the major core joining port 1211 to provide joining with the joining element 4 for signal transmission, and the first major terminal connecting structure 12212 and the second major terminal connecting structure 12222 are respectively located at the major core connecting port 1212 to provide connecting with the first major cable center conductor 211 and the second major cable center conductor 221 for signal transmission.

The minor electrical connector component 13 comprises a minor component insulation core 131, a minor component conductive terminal assembly 132, and a minor component conductive bridging body 133. The minor component insulation core 131 is optionally made of an insulating material, and comprises a minor core joining port 1311 and a minor core connecting port 1312. The minor component conductive terminal assembly 132 and the minor component conductive bridging body 133 are optionally made of a conductive material.

The minor component conductive terminal assembly 132 comprises a first minor terminal 1321 and a second minor terminal 1322, which are configured to provide signal transmission. The first minor terminal 1321 comprises a first minor terminal joining structure 13211 and a first minor terminal connecting structure 13212. The second minor terminal 1322 comprises a second minor terminal joining structure 13221 and a second minor terminal connecting structure 13222. The minor component conductive bridging body 133 comprises a minor shielding conductor abutting structure 1331, a first minor cable abutting structure 1332, and a second minor cable abutting structure 1333.

Wherein, the minor component insulation core 131 is respectively mated with the first minor terminal 1321 and the second minor terminal 1322, such that the first minor terminal joining structure 13211 and the second minor terminal joining structure 13221 are respectively located at the minor core joining port 1311 to provide joining with the joining element 4 for signal transmission, and the first minor terminal connecting structure 13212 and the second minor terminal connecting structure 13222 are respectively located at the minor core connecting port 1312 to provide connecting with the first minor cable center conductor 311 and the second minor cable center conductor 321 for signal transmission.

In the above embodiment, the shielding conductor component combination guiding structure 12131 is configured to guide the shielding conductor component 11 into the shielding conductor component combination space 12132, such that the major electrical connector component 12 and the shielding conductor component 11 are combined to form a first electrical connector combination element A1.

The minor electrical connector component combination guiding structure 12141 is configured to guide the minor electrical connector component 13 into the minor electrical connector component combination space 12142, such that the minor electrical connector component 13 and the first electrical connector combination element A1 are combined to form a second electrical connector combination element A2.

It should be noted that, in the first electrical connector combination element A1, the shielding conductor component longitudinal stop structure 12133 passes through the terminal joining shielding structure threading passage 1111, so as to prevent the shielding conductor component longitudinal stop structure 12133 from interfering with the entry of the shielding conductor component 11 into the shielding conductor component combination space 12132. In the first electrical connector combination element A1, the shielding conductor component longitudinal interference structure 1112 interferes with the longitudinal movement of the shielding conductor component 11 relative to the shielding conductor component longitudinal stop structure 12133, such that the shielding conductor component longitudinal stop structure 12133 is able to stop the shielding conductor component 11 from moving longitudinally out of the shielding conductor component combination space 12132.

In addition, in the first electrical connector combination element A1, the shielding conductor component lateral interference structure 113 enters the shielding conductor component lateral stop structure 12134, so as to prevent the shielding conductor component lateral stop structure 12134 from interfering with the entry of the shielding conductor component 11 into the shielding conductor component combination space 12132. In the first electrical connector combination element A1, the shielding conductor component lateral interference structure 113 interferes with the lateral movement of the shielding conductor component 11 relative to the shielding conductor component lateral stop structure 12134, such that the shielding conductor component lateral stop structure 12134 is able to stop the shielding conductor component 11 from moving laterally out of the shielding conductor component combination space 12132.

In addition, in the first electrical connector combination element A1, the major shielding conductor abutting structure 1231, the first major cable abutting structure 1232, and the second major cable abutting structure 1233 are respectively electrically abutted with the shielding conductor component 11, the first major cable braided layer 212, and the second major cable braided layer 222, such that the major component conductive bridging body 123 electrically bridges the shielding conductor component 11, the first major cable braided layer 212, and the second major cable braided layer 222; the minor shielding conductor abutting structure 1331, the first minor cable abutting structure 1332, and the second minor cable abutting structure 1333 are respectively electrically abutted with the shielding conductor component 11, the first minor cable braided layer 312, and the second minor cable braided layer 322, such that the minor component conductive bridging body 133 electrically bridges the shielding conductor component 11, the first minor cable braided layer 312, and the second minor cable braided layer 322. Accordingly, the major component conductive bridging body 123, the minor component conductive bridging body 133, the shielding conductor component 11, the first major cable braided layer 212, the second major cable braided layer 222, the first minor cable braided layer 312, and the second minor cable braided layer 322 are electrically connected to transmit a shielding signal, thereby providing shielding for signal transmission among the electrical connector 1, the major coaxial cable assembly 2, the minor coaxial cable assembly 3, and the joining element 4, so as to reduce the degree of signal transmission interference among the electrical connector 1, the major coaxial cable assembly 2, the minor coaxial cable assembly 3, and the joining element 4, thereby satisfying the signal transmission requirements of the electrical connector 1.

In the second electrical connector combination element A2, the minor electrical connector component longitudinal stop structure 12143 passes through the minor electrical connector component threading passage 134, so as to prevent the minor electrical connector component longitudinal stop structure 12143 from interfering with the entry of the minor electrical connector component 13 into the minor electrical connector component combination space 12142. In the second electrical connector combination element A2, the minor electrical connector component longitudinal interference structure 135 interferes with the longitudinal movement of the minor electrical connector component 13 relative to the minor electrical connector component longitudinal stop structure 12143, such that the minor electrical connector component longitudinal stop structure 12143 is able to stop the minor electrical connector component 13 from moving longitudinally out of the minor electrical connector component combination space 12142.

In addition, in the second electrical connector combination element A2, the minor electrical connector component lateral interference structure 136 enters the minor electrical connector component lateral stop structure 12144, so as to prevent the minor electrical connector component lateral stop structure 12144 from interfering with the entry of the minor electrical connector component 13 into the minor electrical connector component combination space 12142. In the second electrical connector combination element A2, the minor electrical connector component lateral interference structure 136 interferes with the lateral movement of the minor electrical connector component 13 relative to the minor electrical connector component lateral stop structure 12144, such that the minor electrical connector component lateral stop structure 12144 is able to stop the minor electrical connector component 13 from moving laterally out of the minor electrical connector component combination space 12142.

In addition, in the second electrical connector combination element A2, the terminal joining shielding structure 111 is disposed between the major core joining port 1211 and the minor core joining port 1311, such that the terminal joining shielding structure 111 provides shielding between the first major terminal joining structure 12211 and the first minor terminal joining structure 13211, so as to reduce the degree of signal transmission interference between the first major terminal joining structure 12211 and the first minor terminal joining structure 13211, thereby satisfying the signal transmission requirements of the electrical connector 1; and the terminal connecting shielding structure 112 is disposed between the major core connecting port 1212 and the minor core connecting port 1312, such that the terminal connecting shielding structure 112 provides shielding between the first major terminal connecting structure 12212 and the first minor terminal connecting structure 13212, so as to reduce the degree of signal transmission interference between the first major terminal connecting structure 12212 and the first minor terminal connecting structure 13212, thereby satisfying the signal transmission requirements of the electrical connector 1.

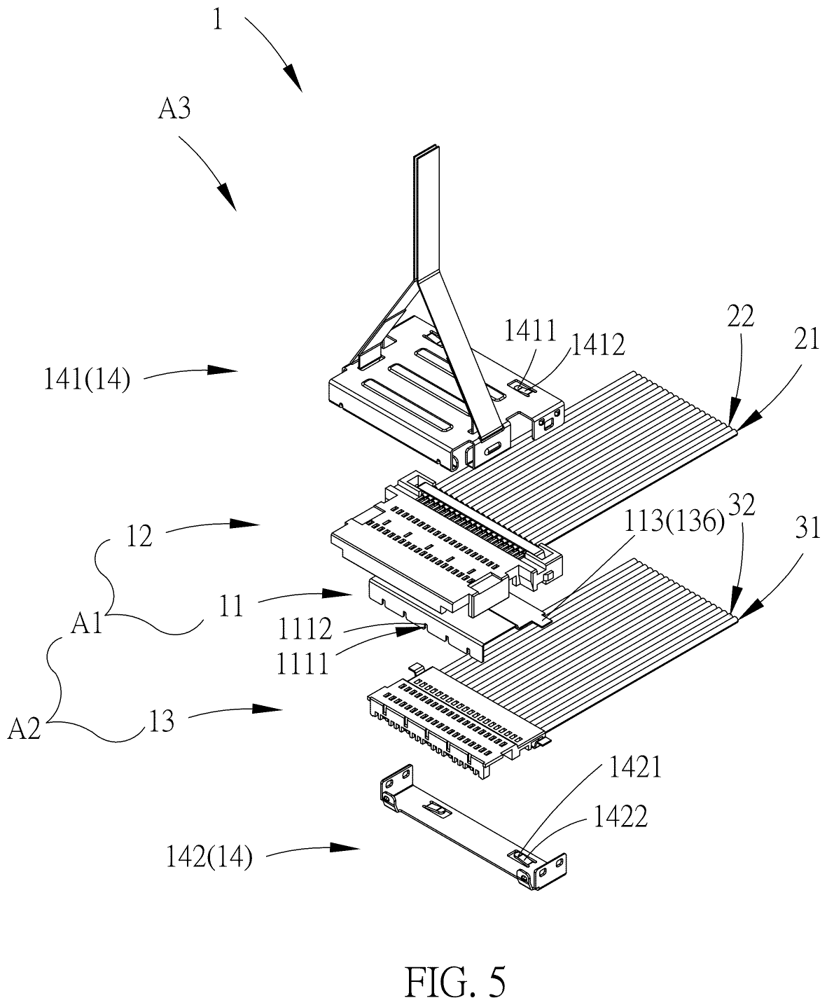

In the embodiment shown in FIG. 5 of the present application, the metal outer cover component 14 comprises a major cover body 141 and a minor cover body 142. The metal outer cover component 14 and the second electrical connector combination element A2 are combined to form a third electrical connector combination element A3.

In the third electrical connector combination element A3, the major cover body 141 extends around the major core joining port 1211, so as to provide shielding for the first major terminal joining structure 12211 to join with the joining element 4, thereby reducing the degree of signal transmission interference at the joining position between the first major terminal joining structure 12211 and the joining element 4, and satisfying the signal transmission requirements of the electrical connector 1; and the major cover body 141 further extends around the major core connecting port 1212, so as to provide shielding for the first major terminal connecting structure 12212 to connect with the first major cable center conductor 211, thereby reducing the degree of signal transmission interference at the connecting position between the first major terminal connecting structure 12212 and the first major cable center conductor 211, and satisfying the signal transmission requirements of the electrical connector 1.

In addition, the minor cover body 142 extends around the minor core joining port 1311, so as to provide shielding for the first minor terminal joining structure 13211 to join with the joining element 4, thereby reducing the degree of signal transmission interference at the joining position between the first minor terminal joining structure 13211 and the joining element 4, and satisfying the signal transmission requirements of the electrical connector 1; and the minor cover body 142 further extends around the minor core connecting port 1312, so as to provide shielding for the first minor terminal connecting structure 13212 to connect with the first minor cable center conductor 311, thereby reducing the degree of signal transmission interference at the connecting position between the first minor terminal connecting structure 13212 and the first minor cable center conductor 311, and satisfying the signal transmission requirements of the electrical connector 1.

Optionally, in the above embodiment, the major cover body 141 and the minor cover body 142 respectively comprise a major cover body abutting structure 1411 and a minor cover body abutting structure 1421. In the second electrical connector combination element A2, the major cover body abutting structure 1411 and the minor cover body abutting structure 1421 are respectively electrically abutted with the major component conductive bridging body 123 and the minor component conductive bridging body 133, such that the major cover body 141 and the minor cover body 142 are respectively electrically connected (electrically bridged) via the major component conductive bridging body 123 and the minor component conductive bridging body 133 to the shielding conductor component 11, the first major cable braided layer 212, the second major cable braided layer 222, the first minor cable braided layer 312, and the second minor cable braided layer 322, to transmit a shielding signal, thereby providing shielding for signal transmission among the electrical connector 1, the major coaxial cable assembly 2, the minor coaxial cable assembly 3, and the joining element 4, so as to reduce the degree of signal transmission interference among the electrical connector 1, the major coaxial cable assembly 2, the minor coaxial cable assembly 3, and the joining element 4, thereby satisfying the signal transmission requirements of the electrical connector 1.

Optionally, in the above embodiment, the major cover body 141 and the minor cover body 142 respectively comprise a major cover body supporting structure 1412 and a minor cover body supporting structure 1422. In the second electrical connector combination element A2, the major cover body supporting structure 1412 and the minor cover body supporting structure 1422 are respectively in contact with the major component conductive bridging body 123 and the minor component conductive bridging body 133, such that the major cover body 141 and the minor cover body 142 respectively provide structural support for the major component conductive bridging body 123 and the minor component conductive bridging body 133, so as to ensure that the major component conductive bridging body 123 is electrically abutted with the shielding conductor component 11 and the first major cable braided layer 212, and further ensure that the minor component conductive bridging body 133 is electrically abutted with the shielding conductor component 11 and the first minor cable braided layer 312.

It should be noted that, in the embodiment of the present application, the aforementioned components may be optionally omitted. For example, the electrical connector may optionally comprise only: a shielding conductor component, a major electrical connector component, and a minor electrical connector component. The shielding conductor component comprises a terminal joining shielding structure and a terminal connecting shielding structure. The major electrical connector component comprises a major component insulation core and a major component conductive terminal assembly. The major component insulation core comprises a major core joining port and a major core connecting port. The major component conductive terminal assembly comprises a first major terminal. The first major terminal comprises a first major terminal joining structure and a first major terminal connecting structure; wherein, the major component insulation core is mated with the first major terminal, such that the first major terminal joining structure is located at the major core joining port to provide joining with the joining element, and the first major terminal connecting structure is located at the major core connecting port to provide connecting with the first major cable center conductor. The minor electrical connector component comprises a minor component insulation core and a minor component conductive terminal assembly. The minor component insulation core comprises a minor core joining port and a minor core connecting port. The minor component conductive terminal assembly comprises a first minor terminal. The first minor terminal comprises a first minor terminal joining structure and a first minor terminal connecting structure; wherein, the minor component insulation core is mated with the first minor terminal, such that the first minor terminal joining structure is located at the minor core joining port to provide joining with the joining element, and the first minor terminal connecting structure is located at the minor core connecting port to provide connecting with the first minor cable center conductor. The major electrical connector component and the shielding conductor component are combined to form a first electrical connector combination element. The minor electrical connector component and the first electrical connector combination element are combined to form a second electrical connector combination element. In the second electrical connector combination element, the terminal joining shielding structure is disposed between the major core joining port and the minor core joining port, such that the terminal joining shielding structure provides shielding between the first major terminal joining structure and the first minor terminal joining structure; and the terminal connecting shielding structure is disposed between the major core connecting port and the minor core connecting port, such that the terminal connecting shielding structure provides shielding between the first major terminal connecting structure and the first minor terminal connecting structure.

In summary, the present application provides an electrical connector capable of transmitting signals, wherein the electrical connector is electrically joinable to a joining element, and the electrical connector is further electrically connectable to a coaxial cable assembly for signal transmission. The electrical connector comprises a terminal joining shielding structure and a terminal connecting shielding structure, wherein the terminal joining shielding structure is configured to provide shielding for the joining between the electrical connector and the joining element, and the terminal connecting shielding structure is configured to provide shielding for the connecting between the electrical connector and the coaxial cable assembly, so as to reduce the degree of signal transmission interference among the electrical connector, the joining element, and the coaxial cable assembly, thereby satisfying the signal transmission requirements of the electrical connector.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, the electrical connector is joined to a joining element, and the electrical connector is connected to a first major coaxial cable and a first minor coaxial cable, the first major coaxial cable comprising a first major cable center conductor, and the first minor coaxial cable comprising a first minor cable center conductor, wherein the electrical connector comprises:
a shielding conductor component, the shielding conductor component comprising a terminal joining shielding structure and a terminal connecting shielding structure;
a major electrical connector component, the major electrical connector component comprising a major component insulation core and a major component conductive terminal assembly; the major component insulation core comprising a major core joining port and a major core connecting port, the major component conductive terminal assembly comprising a first major terminal, the first major terminal comprising a first major terminal joining structure and a first major terminal connecting structure; wherein the major component insulation core is mated with the first major terminal such that the first major terminal joining structure is positioned at the major core joining port for joining with the joining element, and the first major terminal connecting structure is positioned at the major core connecting port for connecting with the first major cable center conductor; and
a minor electrical connector component, the minor electrical connector component comprising a minor component insulation core and a minor component conductive terminal assembly; the minor component insulation core comprising a minor core joining port and a minor core connecting port, the minor component conductive terminal assembly comprising a first minor terminal, the first minor terminal comprising a first minor terminal joining structure and a first minor terminal connecting structure; wherein the minor component insulation core is mated with the first minor terminal such that the first minor terminal joining structure is positioned at the minor core joining port for joining with the joining element, and the first minor terminal connecting structure is positioned at the minor core connecting port for connecting with the first minor cable center conductor; wherein
the major electrical connector component and the shielding conductor component are combined to form a first electrical connector combination element;
the minor electrical connector component and the first electrical connector combination element are combined to form a second electrical connector combination element, in the second electrical connector combination element,
the terminal joining shielding structure is located between the major core joining port and the minor core joining port, such that the terminal joining shielding structure provides shielding between the first major terminal joining structure and the first minor terminal joining structure; and
the terminal connecting shielding structure is located between the major core connecting port and the minor core connecting port, such that the terminal connecting shielding structure provides shielding between the first major terminal connecting structure and the first minor terminal connecting structure.

2. The electrical connector of claim 1, wherein the shielding conductor component is formed of a conductive metal sheet.

3. The electrical connector of claim 1, wherein the first major coaxial cable and the first minor coaxial cable further respectively comprise a first major cable braided layer and a first minor cable braided layer, wherein,
the major electrical connector component further comprises a major component conductive bridging body, the major component conductive bridging body comprising a major shielding conductor abutting structure and a first major cable abutting structure;
the minor electrical connector component further comprises a minor component conductive bridging body, the minor component conductive bridging body comprising a minor shielding conductor abutting structure and a first minor cable abutting structure; and
in the first electrical connector combination element, the major shielding conductor abutting structure and the first major cable abutting structure are respectively electrically abutted with the shielding conductor component and the first major cable braided layer, and the minor shielding conductor abutting structure and the first minor cable abutting structure are respectively electrically abutted with the shielding conductor component and the first minor cable braided layer, such that the major component conductive bridging body, the minor component conductive bridging body, the shielding conductor component, the first major cable braided layer and the first minor cable braided layer are electrically connected to transmit a shielding signal.

4. The electrical connector of claim 3, wherein the electrical connector is further connected to a second major coaxial cable and a second minor coaxial cable, the second major coaxial cable comprising a second major cable center conductor and a second major cable braided layer, the second minor coaxial cable comprising a second minor cable center conductor and a second minor cable braided layer; wherein,
the major component conductive terminal assembly further comprises a second major terminal, the second major terminal comprising a second major terminal joining structure and a second major terminal connecting structure; and the major component insulation core is further mated with the second major terminal, such that the second major terminal joining structure is positioned at the major core joining port for joining with the joining minor terminal connecting structure; and the minor component insulation core is further mated with the second minor terminal, such that the second minor terminal joining structure is positioned at the minor core joining port for joining with the joining element, and the second minor terminal connecting structure is positioned at the minor core connecting port for connecting with the second minor cable center conductor;
the major component conductive bridging body further comprises a second major cable abutting structure;
the minor component conductive bridging body further comprises a second minor cable abutting structure; and
in the first electrical connector combination element, the second major cable abutting structure is electrically abutted with the second major cable braided layer for transmitting the shielding signal; and the second minor cable abutting structure is electrically abutted with the second minor cable braided layer for transmitting the shielding signal.

5. The electrical connector of claim 3, further comprising a metal outer cover component, the metal outer cover component comprising a major cover body and a minor cover body;
the metal outer cover component and the second electrical connector combination element are combined to form a third electrical connector combination element, in the third electrical connector combination element,
the major cover body is extended around the major core joining port, so as to provide shielding for the first major terminal joining structure to join with the joining element; and the major cover body is further extended around the major core connecting port, so as to provide shielding for the first major terminal connecting structure to connect with the first major cable center conductor; and
the minor cover body is extended around the minor core joining port, so as to provide shielding for the first minor terminal joining structure to join with the joining element; and the minor cover body is further extended around the minor core connecting port, so as to provide shielding for the first minor terminal connecting structure to connect with the first minor cable center conductor.

6. The electrical connector of claim 5, wherein the major cover body and the minor cover body respectively comprise a major cover body abutting structure and a minor cover body abutting structure, in the second electrical connector combination element, the major cover body abutting structure and the minor cover body abutting structure are respectively electrically abutted with the major component conductive bridging body and the minor component conductive bridging body, such that the major cover body and the minor cover body are capable of transmitting the shielding signal.

7. The electrical connector of claim 5, wherein the major cover body and the minor cover body respectively comprise a major cover body supporting structure and a minor cover body supporting structure, in the second electrical connector combination element, the major cover body supporting structure and the minor cover body supporting structure respectively contact the major component conductive bridging body and the minor component conductive bridging body, such that the major cover body and the minor cover body respectively provide structural support to the major component conductive bridging body and the minor component conductive bridging body.

8. The electrical connector of claim 1, wherein the major component insulation core further comprises a shielding conductor component combination guiding structure, a shielding conductor component combination space, a shielding conductor component longitudinal stop structure, and a shielding conductor component lateral stop structure; the shielding conductor component combination guiding structure is configured to guide the shielding conductor component into the shielding conductor component combination space, such that the major electrical connector component and the shielding conductor component are combined to form the first electrical connector combination element; in the first electrical connector combination element, the shielding conductor component longitudinal stop structure is configured to stop the shielding conductor component from moving longitudinally out of the shielding conductor component combination space; and the shielding conductor component lateral stop structure is configured to stop the shielding conductor component from moving laterally out of the shielding conductor component combination space.

9. The electrical connector of claim 8, wherein the shielding conductor component longitudinal stop structure is a hook-shaped stop structure disposed at the major core joining port, the terminal joining shielding structure further comprises a terminal joining shielding structure threading passage and a shielding conductor component longitudinal interference structure; in the first electrical connector combination element, the shielding conductor component longitudinal stop structure passes through the terminal joining shielding structure threading passage, so as to prevent the shielding conductor component longitudinal stop structure from interfering with the shielding conductor component entering the shielding conductor component combination space, and the shielding conductor component longitudinal interference structure interferes with the longitudinal movement of the shielding conductor component relative to the shielding conductor component longitudinal stop structure, such that the shielding conductor component longitudinal stop structure is able to stop the shielding conductor component from moving longitudinally out of the shielding conductor component combination space.

10. The electrical connector of claim 8, wherein the shielding conductor component lateral stop structure is a groove-shaped stop structure disposed at the major component insulation core, the shielding conductor component further comprises a shielding conductor component lateral interference structure; in the first electrical connector combination element, the shielding conductor component lateral interference structure enters the shielding conductor component lateral stop structure, so as to prevent the shielding conductor component lateral stop structure from interfering with the shielding conductor component entering the shielding conductor component combination space, and the shielding conductor component lateral interference structure interferes with the lateral movement of the shielding conductor component relative to the shielding conductor component lateral stop structure, such that the shielding conductor component lateral stop structure is able to stop the shielding conductor component from moving laterally out of the shielding conductor component combination space.

11. The electrical connector of claim 8, wherein the major component insulation core further comprises a minor electrical connector component combination guiding structure, a minor electrical connector component combination space, a minor electrical connector component longitudinal stop structure, and a minor electrical connector component lateral stop structure; the minor electrical connector component combination guiding structure is configured to guide the minor electrical connector component into the minor electrical connector component combination space, such that the minor electrical connector component and the first electrical connector combination element are combined to form the second electrical connector combination element; in the second electrical connector combination element, the minor electrical connector component longitudinal stop structure is configured to stop the minor electrical connector component from moving longitudinally out of the minor electrical connector component combination space; and the minor electrical connector component lateral stop structure is configured to stop the minor electrical connector component from moving laterally out of the minor electrical connector component combination space.

12. The electrical connector of claim 11, wherein the minor electrical connector component longitudinal stop structure is a hook-shaped stop structure disposed at the major core joining port, the minor electrical connector component further comprises a minor electrical connector component threading passage and a minor electrical connector component longitudinal interference structure; in the second electrical connector combination element, the minor electrical connector component longitudinal stop structure passes through the minor electrical connector component threading passage, so as to prevent the minor electrical connector component longitudinal stop structure from interfering with the minor electrical connector component entering the minor electrical connector component combination space, and the minor electrical connector component longitudinal interference structure interferes with the longitudinal movement of the minor electrical connector component relative to the minor electrical connector component longitudinal stop structure, such that the minor electrical connector component longitudinal stop structure is able to stop the minor electrical connector component from moving longitudinally out of the minor electrical connector component combination space.

13. The electrical connector of claim 11, wherein the minor electrical connector component lateral stop structure is a groove-shaped stop structure disposed at the major component insulation core, the minor electrical connector component further comprises a minor electrical connector component lateral interference structure; in the second electrical connector combination element, the minor electrical connector component lateral interference structure enters the minor electrical connector component lateral stop structure, so as to prevent the minor electrical connector component lateral stop structure from interfering with the minor electrical connector component entering the minor electrical connector component combination space, and the minor electrical connector component lateral interference structure interferes with the lateral movement of the minor electrical connector component relative to the minor electrical connector component lateral stop structure, such that the minor electrical connector component lateral stop structure is able to stop the minor electrical connector component from moving laterally out of the minor electrical connector component combination space.
